(19) United States
(12) Patent Application Publication
(10) Pub. No.: US 2003/0182221 A1
(43) Pub. Date: Sep. 25, 2003

(54) Financial agent

(75) Inventors: Simon J. Forrest, Dundee (GB); Adrian Shields, Fife (GB)

Correspondence Address: Michael Chan, NCR Corporation, 1700 South Patterson Blvd., Dayton, OH, 45479-0001, US

(73) Assignee: NCR Corporation

(21) Appl. No.: 10/390,519

(22) Filed: Mar. 17, 2003

(30) Foreign Application Priority Data
Mar. 19, 2002 (GB) 0206394.9

(51) Int. Cl. G06F 17/60

(52) U.S. Cl. 705/36

(57) ABSTRACT

A financial agent (70) resident on a secure network terminal, such as an ATM (10), is described. The financial agent (70) is capable of operating as a financial instrument having a predetermined spending limit. The agent (70) is also operable to create one or more sub-agents not being capable of operating as a financial instrument but being able to negotiate, whereby the financial agent (70) is able to create a sub-agent to negotiate with other entities, without providing the sub-agent with any authority for executing a transaction or any knowledge of the spending limit available. A financial agent system (2), and a method of conducting transactions using a financial agent (70), are also described.

### BACKGROUND OF THE INVENTION

The present invention relates to a financial agent. In particular, the invention relates to a financial agent for performing transactions on behalf of a user, such as electronic commerce (e-commerce) transactions.

The increase in electronic commerce has also given rise to the proposed use of intelligent agents to conduct transactions on a user's behalf. Intelligent agents are a class of software comprising code and data. Intelligent agents can be mobile or static. Mobile agents can be transmitted around network computing environments; whereas static agents do not move from a computing device in which they are instantiated.

One definition of an intelligent agent is a software entity that carries out some set of operations on behalf of a user or another program, with some degree of independence or autonomy, and in so doing, employs some knowledge or representation of the user's goals or desires.

There are, however, disadvantages in using intelligent agents for commercial transactions. One disadvantage is that an agent may be compromised, or may divulge more information about its owner than is necessary. In e-commerce, disclosing sensitive information may have an adverse effect on concluding a transaction or on the price paid for a transaction.

Another disadvantage is that an agent typically requires a relatively long training period before it can learn the preferences of its owner (for example, what types of food, clothes, entertainment, and such like that the owner likes, and conversely, what types of food, clothes, entertainment, and such like that the owner does not like). This makes it undesirable to terminate an agent once it has learnt its owner's preferences.

### SUMMARY OF THE INVENTION

It is among the objects of an embodiment of the present invention to provide a financial agent that obviates or mitigates one or more of the above disadvantages.

According to a first aspect of the present invention there is provided a financial agent characterized in that the agent is capable of operating as a financial instrument having a predetermined spending limit, the agent being operable to create one or more sub-agents not being capable of operating as a financial instrument but being able to negotiate, whereby the financial agent is operable to create a sub-agent to negotiate with other entities, without providing the sub-agent with any authority for executing a transaction or any knowledge of the spending limit available.

By virtue of this aspect of the invention a financial agent is provided that is able to spawn sub-agents for performing negotiations. These sub-agents are not able to disclose confidential information as they are only provided with a sub-set of the information carried by the financial agent. A financial agent may spawn multiple sub-agents, each sub-agent being allocated part of a task, so that no agent (apart from the financial agent) is aware of the entire task.

The term “financial instrument” is used herein to denote a mechanism for effecting payment.

Preferably, the financial agent is resident on a secure network. Examples of a secure network may include a financial institution's branch network, an automated teller machine (ATM) network, a retail point of sale (PoS) network, or such like.

The sub-agents may be mobile agents or may be static agents.

Preferably, the financial agent may be used in a similar way to a credit card, for example, by having an account number, an issue date, an expiry date, and a credit limit. The time between the issue date and the expiry date may be relatively long, for example, five years, ten years, or even fifty years. If the financial agent is intended to be a life-long agent, then there may be a long time (for example, seventy years) between the issue date and expiry date.

According to a second aspect of the present invention there is provided a secure network terminal having an agent infrastructure for financial agents, the terminal comprising a secure area for allowing financial agents to execute transactions with other entities, and a communications area for allowing financial agents to transmit sub-agents into a network for conducting negotiations, and for receiving the transmitted sub-agents from the network having completed negotiations, whereby a financial agent is capable of operating as a financial instrument having a predetermined spending limit and is able to execute a transaction after receiving completed negotiations from a sub-agent.

In a preferred embodiment, the secure networked terminal is an ATM. Alternatively, the secure networked terminal may be a point of sale (PoS) terminal.

According to a third aspect of the present invention there is provided a method of conducting transactions, the method comprising the steps of: providing a financial agent capable of operating as a financial instrument having a predetermined spending limit; creating a sub-agent having a sub-set of information carried by the financial agent and being unaware of the spending limit; allowing the sub-agent to conduct negotiations with another entity; executing a transaction using the financial agent after the sub-agent has satisfactorily concluded negotiations.

According to a fourth aspect of the present invention there is provided a financial agent system comprising a secure network and an open network (such as the Internet), where a financial agent capable of operating as a financial instrument having a predetermined spending limit is resident on the secure network, but is operable to create and send sub-agents to the open network for negotiating transactions with other entities, so that the financial agent is able to execute transactions securely once negotiations have been concluded by a sub-agent.

### BRIEF DESCRIPTION OF THE DRAWINGS

These and other aspects of the present invention will be apparent from the following specific description, given by way of example, with reference to the accompanying drawings, in which:

FIG. 1 is a simplified block diagram showing a financial institution's self-service terminal network, according to one embodiment of the present invention;

FIG. 2 is simplified block diagram showing the architecture of a self-service terminal of the network of FIG. 1;.

FIG. 3 is a simplified schematic diagram illustrating the main components of a financial agent for executing on the terminal of FIG. 2;

FIG. 4A is a flowchart illustrating the creation of the financial agent of FIG. 3; and

FIG. 4B is a flowchart illustrating the use of the financial agent of FIG. 3.

### DETAILED DESCRIPTION

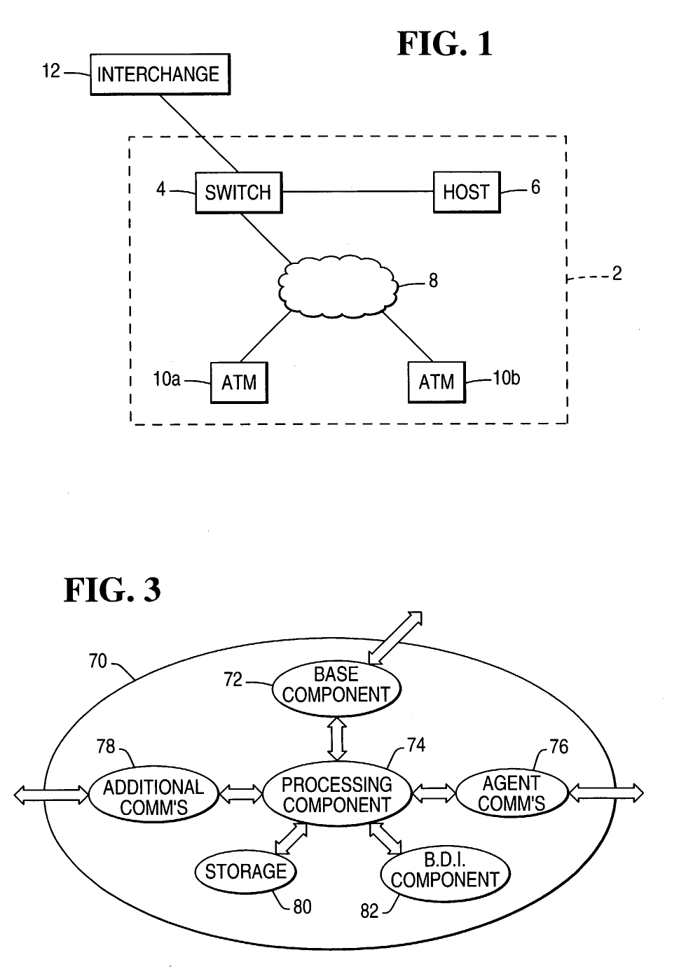

Reference is first made to FIG. 1, which is a simplified block diagram showing a financial institution's self-service terminal system 2, according to one embodiment of the present invention. The system 2 comprises: a switch 4 coupled to a host 6, and connected by a secure network 8 to a plurality of self-service terminals 10, in the form of ATMs (only two of which are shown). The switch 4 is also connected to an interchange 12.

The host 6 is typically located in a back-office of the financial institution and authorizes transactions relating to account holders with the financial institution. The switch 4 routes transactions to either the host 6 (where a transaction is executed on an ATM 10 by an account holder with the financial institution), or to the interchange 12 (where a transaction is executed on an ATM 10 by an account holder with a third party institution).

The ATM 10 comprises a plurality of modules for enabling transactions to be executed and recorded by the ATM 10. These ATM modules comprise: a controller module 14, a display module 20, a card reader/writer module 22, an encrypting keypad module 24, a receipt printer module 26, a cash dispenser module 30, a journal printer module 32 for creating a record of every transaction executed by the ATM 10, and a network connection module 34 (in the form of a network card for an IP network) for accessing the switch 4 and the host 6.

The controller 14 comprises a BIOS 40 stored in non-volatile memory, a microprocessor 42, associated main memory 44, storage space 46 in the form of a magnetic disk drive, and a display controller 48 in the form of a graphics card.

The display module 20 is connected to the controller module 14 via the graphics card 48 installed in the controller module 14. The other ATM modules (22 to 34) are connected to the ATM controller 14 via a device bus 36 and one or more internal controller buses 38.

When the ATM is powered up, a secure booting-up process is performed, for example, using the process described in U.S. Pat. No. 6,209,099 “Secure data processing method and system” assigned to NCR Corporation. During the boot-up process, the main memory 44 is loaded with an ATM operating system kernel 52, and an ATM application 54 in a secure manner. Furthermore, the ATM modules (20 to 34) and other components (40, 46, 48) are authenticated.

As is well known in the art, the operating system kernel 52 is responsible for memory, process, task, and disk management. The ATM application 54 is responsible for controlling the operation of the ATM 10. In particular, the ATM application 54 provides the sequence of screens used in each transaction (referred to as the application flow); monitors the condition of each module within the ATM (state of health monitoring); and obtains authorization for transactions from the host 6 or a third party system via the switch 4.

The term “screen” is used herein to denote the graphics, text, controls (such as menu options), and such like, that are presented on an SST display; the term “screen” as used herein does not refer to the hardware (that is, the display) that presents the graphics, text, controls, and such like. Typically, when a transaction is being entered at an SST, a series of screens are presented in succession on the SST display, the next screen displayed being dependent on a user entry or activity relating to the current screen. For example, a first screen may request a user to insert a card; once a card has been inserted a second screen may invite the user to enter his/her PIN; once the final digit of the PIN has been entered, a third screen may invite the user to select a transaction from a list of transactions; and so on.

The controller 14 provides a financial agent environment (illustrated by block 60) in which agents are executed. The agent environment 60 is implemented by: the processor 42; an agent environment manager 62, which is securely loaded into the memory 44; and a memory portion 64 reserved for use by financial agents. The operating system 52 supports memory protection so that memory portion 64 cannot be accessed by the ATM application 54 or the operating system 52, only by the environment manager 62.

In this embodiment, the environment 60 is based on a Java (trade mark) Virtual Machine executing on the processor 42, and Java agents are used.

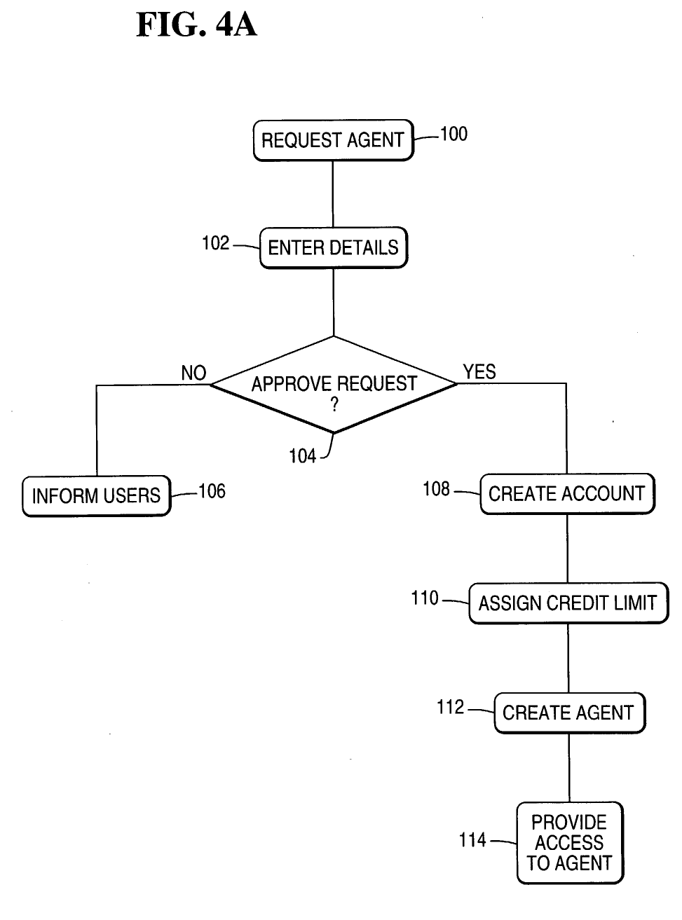

Reference is now made to FIG. 3, which is a simplified schematic diagram illustrating the main components of a financial agent 70.

Financial agent 70 has a base component 72, which is instantiated by the environment manager 62 when the financial agent 70 is created. The base component 72 includes an identifier uniquely identifying the financial agent 70. The base component 72 interfaces with the environment manager 62 to issue requests to the environment manager 62 (for example, to ask the environment manger 62 to create another agent, or to move the agent to a different location).

Financial agent 70 also has a processing component 74 for processing data. The agent 70 can receive data from other agents via an agent communication component 76, or from other devices (such as Web servers) via an additional communication component 78. In this embodiment, the agent communication component 76 is implemented by a logical port, and the additional communication component 78 is implemented by a different logical port.

Financial agent 70 includes some local storage 80 for storing agent parameters, data for processing, processed data, and such like.

Financial agent 70 also includes a beliefs/desires/intentions (BDI) component 82 for storing information representing the agent owner's views, so that the agent 70 will not recommend or execute any transaction incompatible with the beliefs, desires, or intentions of the agent owner, as recorded in the BDI component 82.

The environment manager 62 includes an agent interface (not shown) for transmitting outgoing intelligent agents and receiving incoming intelligent agents. The environment manager 62 monitors an assigned port number (which represents a logical channel in the processor) on the IP address of the network card 34 to detect an incoming agent.

The environment manager 62 also performs “housekeeping” tasks. For example, the environment manager 62 instantiates received agents so that they are executed in the memory portion 64, but have no access to the memory space used by the ATM application 54 or the operating system 52.

The environment manager 62 includes a directory (not shown) for recording which agents are currently instantiated in the memory portion 64.

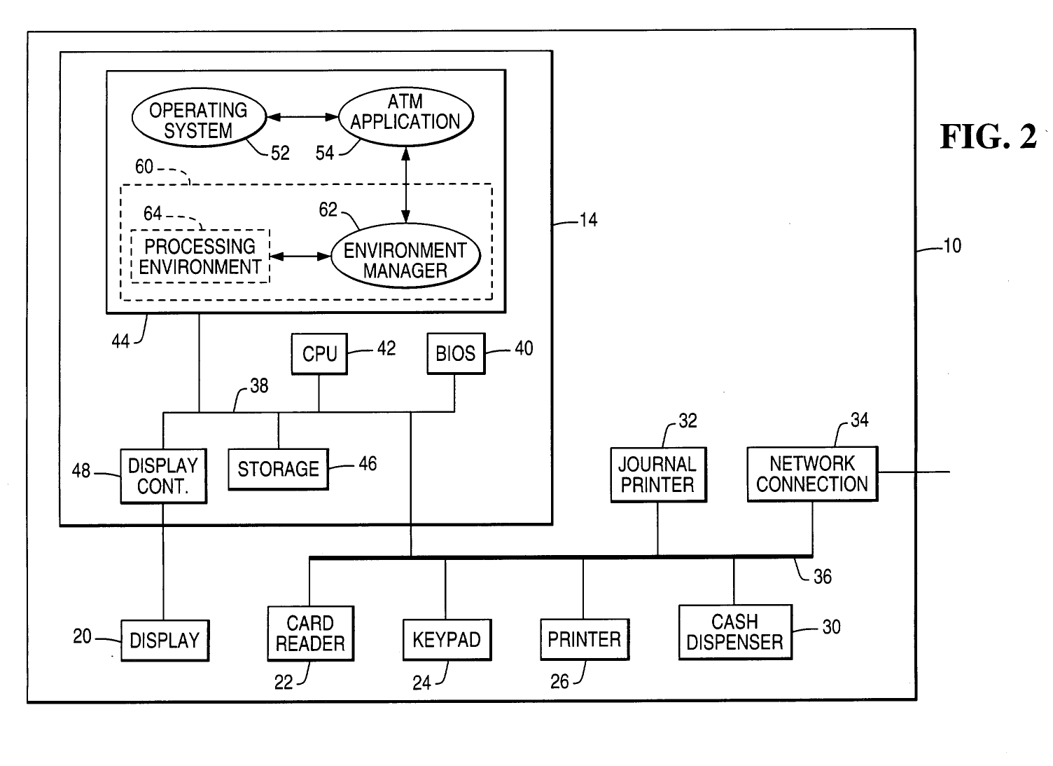

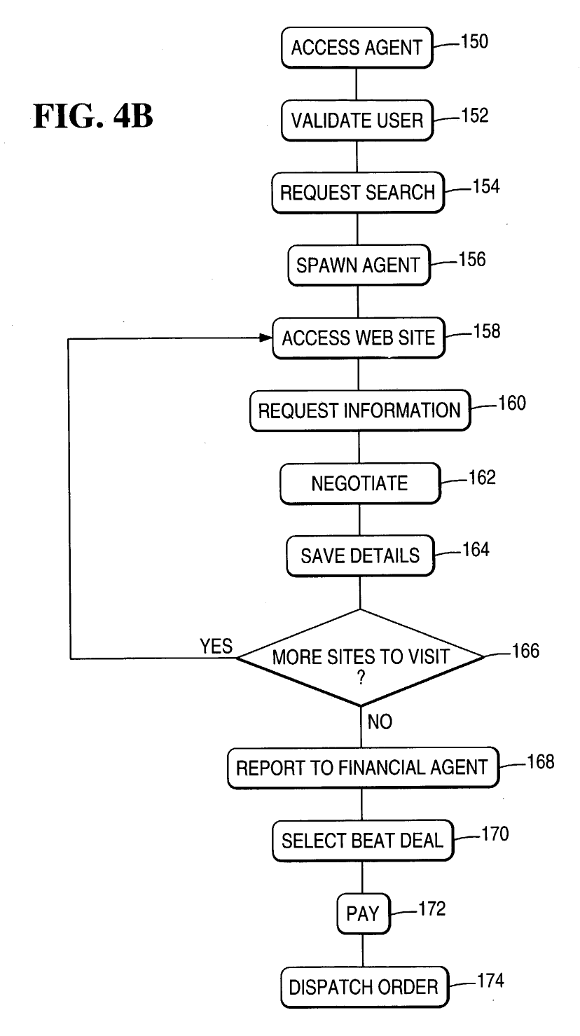

An example of the creation of a financial agent 70 will now be described with reference to FIGS. 1 to 4A, where FIG. 4A is a flowchart illustrating the steps involved in creating a financial agent 70.

Initially, a user applies to a financial institution for a financial agent 70 (step 100), for example, by selecting an appropriate option on a screen at the ATM 10.

The user is then prompted to enter details (step 102), including personal details, preferences, contact details, and such like. Personal details may include: name, age, gender, date of birth, income, mother's maiden name, names of schools attended, and such like. Contact details may include, postal address, email address, telephone number, cellular telephone number (for SMS contact), and such like. Preferences may include lifestyle choices, brand loyalties or dislikes, and such like. These details can be augmented, amended, or updated at a later time.

The financial institution then examines the request (step 104) to determine if a financial agent should be provided for the user. This examination may be performed by software or by a human operator, or both. The examination may involve checking the user's credit rating, and any other financial information that may be relevant.

If the financial institution determines that a financial agent is not to be provided to the user, the user is informed that his/her request has been denied (step 106). If the examination can be performed quickly, then this information may be provided to the user at the ATM 10 after a short delay. However, if the examination takes a substantial amount of time, then the user may be informed using a different channel, for example, by letter or by SMS. In the context of communication between a customer and a vendor, a channel refers to any means for conveying the communication, such as, a postal service, electronic mail, telephone, facsimile, SMS, ATM network, Internet, bank branch, and such like.

If the financial institution approves the user's request for a financial agent, then the institution creates an account for the user (step 108), and assigns a spending limit (step 110) to this account.

The financial institution then creates (either at the ATM 10 or at the host 6) a financial agent 70 (step 112) unique to the user. The base component 72 of the agent 70 is programmed with an identifier for associating the agent 70 with the user. Any beliefs, desires, or intentions that the user supplied at step 102 (for example, as preferences) are programmed into the BDI component 82 of the agent 70. The storage component 80 of the agent is programmed with an account number, financial institution identification details, and a credit limit (which is the predetermined spending limit assigned by the financial institution at step 110) to enable the agent 70 to execute financial transactions.

The financial institution then provides the user with access to the newly-created agent 70 (step 114). This may be implemented by supplying the user with a code required to access the agent 70. In this embodiment, the agent 70 is resident on the financial institution's system 2, and the user can access the agent 70 using a wireless device (such as a personal digital assistant or a cellular radio-frequency telephone). The ATM 10 securely transfers a digital certificate (comprising a unique public/private key-pair, the public key of which is signed using the financial institution's secret key) to the user's wireless device for storage in the SIM (subscriber identity module) or WIM (wireless identity module) of the device. This key-pair is used at an ATM to authenticate the user's access to the agent 70.

The use of this intelligent financial agent 70 for purchasing a holiday (as an example of a transaction being executed by the financial agent) will now be described with reference to FIG. 4B.

Initially, the user accesses (step 150) the financial agent 70 using a secure wireless device, such as a Nokia (trade mark) 5510 cellular radio-frequency telephone (hereinafter referred to as a cellphone), including a digital certificate stored in the cellphone's SIM. The user may access the financial agent 70 using a microbrowser executing on the user's cellphone. In this embodiment a WAP-based microbrowser is used.

The financial agent 70 authenticates the user (step 152) to ensure that the user is valid. This authentication may include details from the cellphone's SIM and a passcode entered by the user.

The user then requests (step 154) the agent 70 to perform a task; in this example the task is to locate the best deal for a ten day holiday in Spain. The finance agent 70 saves the details of this request in the storage component 80. The details may include the length of stay, departure date/time, the number of people travelling, the preferred location, the type and quality of accommodation, and such like. The details may include the addresses of Web sites to visit to obtain the information; alternatively, the financial agent 70 may determine which Web sites should be visited without requiring the user to provide uniform resource locators (URLs).

The financial agent 70 requests the environment manager 62 to create (step 156) a new agent (a sub-agent) based on information provided by the financial agent 70. The information provided by the financial agent 70 comprises the request details saved in the storage component 80, but does not include details about the account number or spending limit of the financial agent 70. The sub-agent operates as a Web client for performing searches and conducting negotiations with Web sites.

Once it has been created, the sub-agent uses the additional communications component 78 to access Web sites (step 158) by issuing a GET command using the URLs recorded in the storage component.

Once the desired Web page has been retrieved, the sub-agent requests information (step 160) by issuing POST commands to complete any forms or provide information required to complete a search for details and pricing for a ten day holiday in Spain. In this example, the information includes the request details (such as destination, accommodation, and travel information).

The sub-agent then negotiates with software sales agents at the Web site (step 162) to determine the best deal available for the holiday, which may include modifying the request details slightly.

The sub-agent saves details of the best deal (step 164) for that Web site. The details include payment details, availability of the holiday, and a certified public key from the merchant operating the Web site.

The sub-agent then determines whether there are any more Web sites to visit (step 166).

If there are more Web sites to visit, then the sub-agent repeats steps 158 to 164, otherwise the sub-agent reports to the financial agent 70 (step 168) by providing the stored information about the best deals obtained. The sub-agent terminates after reporting to the financial agent 70.

The financial agent 70 then selects the most appropriate option (step 170) from the list of saved best deals provided by the sub-agent. This involves the financial agent 70 comparing each of the saved best deals with the BDI component 82 to ensure that the deal is consistent with the preferences recorded in the BDI component 82, and to rate each deal based on: compliance with these preferences, the price of the deal, the trustworthiness of the supplier, and such like.

If the financial agent 70 is unsure which of two or more options is more preferable, then the financial agent 70 may send a message to the user asking the user to select the desired option. The financial agent 70 uses the additional communications component 78 to send a message (such as an email or an SMS text message) to the user's cellphone, and awaits a response from the user as to which option is most preferable.

Once the user has responded, the financial agent 70 arranges for payment to be made to the supplier of the best deal (step 172). The financial agent 70 encrypts the payment details (including the account number, the expiry date, the issue date, the amount to be paid, and an identifier of the merchant to be paid) using the merchant's public key, and transmits the payment details to the merchant using a secure Internet connection.

The merchant then dispatches the order (step 174), in this example, electronic tickets may be provided for flights to Spain.

This embodiment has the advantage that users are provided with a lifetime intelligent agent that has approved spending power for on-line purchases, similar to the limit on credit cards. The user can dynamically interact with the agent through a secure mobile device whenever the agent presents the results of a search or investigation it had been asked to carry out.

The user can create an account at a secure terminal, such as an ATM, and provide the agent with a fixed limit of spending power that can be used and negotiated on the user's behalf within the on-line commercial environment.

By creating this virtual “account”, the user has the ability to send the agent out on the user's behalf for serving the user's needs, such as by bidding at on-line auctions, or by negotiating at Web sites. The agent can employ various privacy techniques that allow it to search the Web in such a way that that the desired information, service, or such like is never divulged to any of the services that the agent uses.

The user has the ability to define various “haggling” strategies that the agent may use to access various information resources or services that the user may desire or require.

The user may also register his/her preferences for use in various searches, such as brands he/she likes or trusts, providers that are to be used for various products, and such like. This allows the agent to provide targeted information to the user and avoid offering him/her products from manufacturers that he/she did not like. This also provides the agent with additional search criteria for refining searches without having to consult the user repeatedly.

The agent may update the stored BDI preferences after confirming with the user that the changes are to be made to his/her preference profile. This provides the agent with a form of automated learning that allows the personal profile to become tailored to the user over time. The user controls this information and must provide consent prior to the information being disclosed, even to the financial institution hosting the agent, thereby preserving the user's privacy.

When the user is required to provide input to the system, then the agent contacts the user, through one of a plurality of on-line mechanisms. These may be through e-mail, SMS messaging or by using a wireless interactive protocol such as WAP. This allows the user to provide an interactive response through a telephone either to accept a transaction or to redefine the criteria used by the agent to create the decision.

Using a non-interactive messaging system, like SMS, allows users without WAP phones, or users who do not require real-time interactive access to the service to go to their nearest ATM and access the service through this secure end-point. The added advantage of using this interface is that the user may also access the information used to create the agent and change the fundamental agent parameters, such as the value (spending limit) of the agent if the user's personal circumstances changed. For example, at the end of the month the user may want to delay purchase of an item. Alternatively, if a search for a desired product has not produced any results, then the user may increase the agent's spending limit.

By accessing the agent at an ATM, the user can access the system in a secure manner through a consistent interface that he/she is familiar with, without having to learn how to use a new interface, and without having to trust the Internet.

By accessing the agent through an ATM, a user is provided with financial services through a single interface that is secure and trustworthy, without having to store or transfer financial details or money to a third party.

The user provides information for a single agent, rather than having to create a separate agent for each transaction. The user can then amend the spending limit, or a particular constraint or restriction, for a current task. The agent can gain additional value, in a similar way to a credit limit on a credit card being raised through use and regular repayment. Interest may be charged on any purchases made using the agent, or on any charges not paid at the end of a credit free period (for example, one month). Alternatively, funds spent may be deducted directly from a user's bank account.

Some transaction may continue over an extended period of time, for example a number of weeks or months. Typical transactions extending over a long time period may include purchasing a house, a car, a boat, or such like, where the agent monitors a dynamic market. These large value purchases could be pre-arranged so that that the user's agent has its spending limit temporarily increased for a specific purchase. The financial institution owning and hosting the agent may arrange for different repayment rates for the value that the agent holds for various periods of time.

The user's financial agent spawns sub agents that access various sites that provide services, so that a user is provided with information from a number of sources, thereby allowing the user to select the most appropriate deal. These sub-agents do not have the full information about the required purchase, they only have sub-parts of the required information to allow them to complete their portion of the overall task.

The sub-agents may each perform part of a task, such as a search, so that no agent is able to provide the Web sites being accessed with full details of the search being conducted. This protects the privacy of the user and also protects the search because it is much more difficult to inflate the price of the goods and/or services due to the number of agents searching for the same information. The sub-agents may not be provided with the actual value that they are willing to pay they may have to query the master agent (the financial agent) using an encrypted query to find if an offered value is suitable. Using this architecture only the financial agent controlling the search has knowledge of the value that the user is willing to pay. This price information is never released into the Internet, and is therefore secure.

After an agent has made a purchase it may contact the user through the wireless interface to provide a link to any information about the transaction, such as receipts, warranties, vouchers, or such like.

The security of the system is managed by encrypting communications between the financial agent and sub-agents, and by using certificates to verify all communications between the agents.

The security of the registration process is preferably effected by a secure end point such as an ATM, at which the user uses his/her bank card as authentication and perhaps an additional password or security token provided by the financial institution to allow access to the agent service.

The connection to the user's mobile device is secured using a security token or digital certificates held in the SIM or Wireless Identity Module (WIM) in the mobile phone or PDA. This allows server side as well as client side authentication and secure access to the financial institution's network. The security token or certificate may be downloaded to the mobile device during registration at the ATM or provided to the user in some other secure manner.

Various modifications may be made to the above described embodiment within the scope of the invention, for example, in other embodiments, a user may be supplied with a security token instead of a digital certificate. In other embodiments, the security token or digital certificate may be supplied to the user in a different manner than by transfer from an ATM.

In other embodiments, a user may apply for a financial agent using another channel, for example, by a telephone connection to bank staff or a call center, by a Web site, by visiting a branch, by email, or by a letter.

In other embodiments, a user may access the financial agent 70 by using a local communication protocol (such as a Bluetooth connection) at the ATM 10.

In other embodiments, the financial agent may contact the user prior to making any purchase. In other embodiments, the financial agent may be resident on a secure network owned by a trusted third party, where the trusted third party may host financial agents as a business service.

In other embodiments, the financial agent may be a mobile agent rather than a static agent.

In other embodiments, a sub-agent may include a copy of all or part of the BDI component 82 from the financial agent 70, so that only results consistent with the BDI preferences are saved.

What is claimed is:

1. A financial agent comprising:
means for enabling the agent to operate as a financial instrument having a predetermined spending limit;
means for enabling the agent to create one or more sub-agents incapable of operating as a financial instrument and capable of negotiating; and
means for creating a sub-agent to negotiate with other entities, without providing the sub-agent with any authority for executing a transaction or any knowledge of the spending limit available.

2. An agent according to claim 1, wherein the financial agent is resident on a secure network.

3. An agent according to claim 2, wherein the financial agent may be used in a similar way to a credit card.

4. An agent according to claim 1, wherein the financial agent may be used in a similar way to a credit card.

5. A secure network terminal having an agent infrastructure for financial agents, the terminal comprising:
a secure area for allowing financial agents to execute transactions with other entities; and
a communications area for (i) allowing financial agents to transmit sub-agents into a network for conducting negotiations, and (ii) receiving the transmitted sub-agents from the network having completed negotiations, such that a financial agent is capable of operating as a financial instrument having a predetermined spending limit and is capable of executing a transaction after receiving completed negotiations from a sub-agent.

6. A terminal according to claim 5, wherein the secure networked terminal comprises an automated teller machine (ATM).

7. A method of conducting transactions, the method comprising the steps of:
providing a financial agent capable of operating as a financial instrument having a predetermined spending limit;
creating a sub-agent having a sub-set of information carried by the financial agent and being unaware of the spending limit;
allowing the sub-agent to conduct negotiations with another entity; and
executing a transaction using the financial agent after the sub-agent has satisfactorily concluded negotiations.

8. A financial agent system comprising:
a secure network;
an open network; and
a financial agent capable of operating as a financial instrument having a predetermined spending limit and being resident on the secure network, the financial agent being operable to create and send sub-agents to the open network for negotiating transactions with other entities, so that the financial agent is able to execute transactions securely once negotiations have been concluded by a sub-agent.
